(19) United States
(12) Patent Application Publication
(10) Pub. No.: US 2023/0023169 A1
(43) Pub. Date: Jan. 26, 2023

(54) LAMINATE

(71) Applicant: Pangea Made, Inc., Tokyo (JP)

(72) Inventors: Naoyuki TANIGUCHI, Tokyo (JP); Yoshiaki SUZUKI, Tokyo (JP); Jeffrey Dean MILLER, Rochester Hills, MI (US)

(21) Appl. No.: 17/783,625

(22) PCT Filed: Oct. 14, 2020
(86) PCT No.: PCT/JP2020/038729

§ 371 Date: Jun. 8, 2022

(30) Foreign Application Priority Data
Dec. 9, 2019 (JP) 2019-221856

(51) Int. Cl. B32B 9/04; B32B 5/02; B32B 9/02; B32B 7/12

(52) U.S. Cl. CPC B32B 9/047; B32B 5/022; B32B 9/025; B32B 7/12; B32B 2307/732; B32B 2605/003; B32B 2255/02; B32B 2255/26; B32B 2262/062; B32B 2307/5825; B32B 2250/02; B32B 2307/51

(57) ABSTRACT

A laminated body is disclosed. The laminate body has a leather layer comprising natural leather in which all or a portion of the reticular layer has been removed, a fiber layer comprising natural and/or synthetic fibers positioned at the rear-side of the leather layer, and an adhesive layer between the leather layer and the fiber layer, wherein, in the leather layer, the proportion of the thickness of the reticular layer is 5% or less and the proportion of the thickness of the papillary layer is 95% or more.

### TECHNICAL FIELD

The present invention relates to a laminated body, especially a laminated body wherein a reticular layer-removed leather and a fiber material are laminated.

### BACKGROUND ART

Conventionally, a natural leather has been used in many fields including vehicle interior materials, interior materials, bags, shoes, clothing, and the like, making use of its typical texture and excellent material properties such as high quality. However, natural leather products generate loose grain (a phenomenon wherein the papillary layer and the reticular layer of the leather delaminate and the appearance deteriorates) during usage, and it is becoming a big issue.

Also, as the natural leather is a heavy material, its weight was concerned when products such as bags are produced using the natural leather. Further, the natural leather products sometimes felt hard and uncomfortable especially when starting usage. Therefore, if these points on the natural leather is improved, there is a possibility that the attraction of the natural leather will be further enhanced, and the demand will be stimulated.

As a material using the natural leather, Patent Literature 1 describes a leather laminated body wherein a part of back of the leather is removed and is bonded to base material using hot melt adhesive. Also, Patent Literature 2 describes a skin material wherein the natural leather and a mesh cloth are laminated. Further, Patent Literature 3 discloses to specify the ratio of the thickness of a grain side layer to the thickness of the cowhide leather in order to make a material with low heat shrinkage suitable for the instrument panel of automobiles.

### PRECEDING ART DOCUMENTS

### PATENT LITERATURE

PATENT LITERATURE 1 U.S. Pat. No. 6,008,374

PATENT LITERATURE 2 U.S. Pat. No. 6,386,329

PATENT LITERATURE 2 Publication of Japanese Laid-Open Patent Publication No. 2013-25532

### OUTLINE OF INVENTION

### ISSUES TO BE SOLVED BY THE INVENTION

However, in the existing technology, it cannot be said that the aforementioned issues are being sufficiently resolved. The present invention has been done in view of the aforementioned issues, and its purpose is to realize an improvement on the weight and hardness while making use of the high quality of the natural leather and suppressing the deterioration in the appearance by the loose grain.

### MEANS FOR SOLVING THE PROBLEM

The present inventors came to complete the present invention as a result of various consideration, finding out that the above issues could be resolved by a drastic removal of the reticular layer of the natural leather and a replacement with a fiber layer.

To resolve the aforementioned issues, it is resolved through the laminated body of the present invention. In other words, the present invention is:

1) The leather layer consisting of the natural leather wherein a part or all of the reticular layer is removed,

2) the fiber layer consisting of natural/synthetic fibers positioned at the back side of the aforementioned leather layer,

3) the adhesive layer between the aforementioned leather layer and the aforementioned fiber layer,

4) a laminated body having the above, and is related to:

5) a laminated body wherein the percentage of the thickness of the reticular layer in the aforementioned leather layer is 5% or lower, and the percentage of the thickness of a papillary layer is 95% or higher,

6) The laminated body described in (1) wherein the thickness of the aforementioned leather layer is lower than 0.3-0.5 mm,

7) The laminated body described in (1) or (2) wherein the elongation percentage is 30-80%,

8) The laminated body described in any of (1)-(3) wherein the aforementioned fiber layer is non-woven consisting of a short fiber made from a natural fiber,

9) Vehicle interior materials having the laminated body described in any of (1)-(4),

10) Vehicle seats having the laminated body described in any of (1)-(4).

### EFFECTS OF INVENTION

According to the present invention, it becomes possible to realize the improvement in the weight and hardness while making use of the high quality of the natural leather and suppressing the deterioration in the appearance by the loose grain.

### BRIEF DESCRIPTION OF THE DRAWINGS

FIG. 1 It is a cross section of the laminated body related to one embodiment of the present invention.

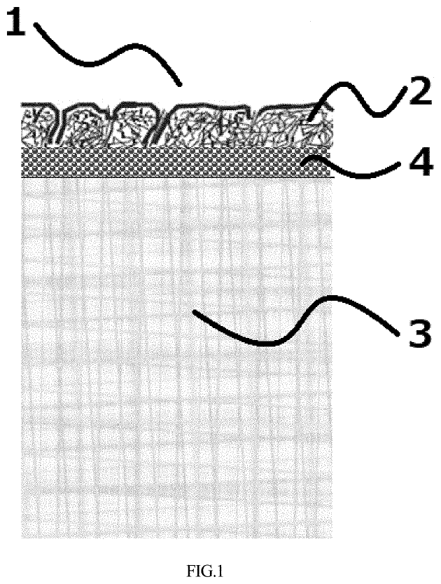

### DESCRIPTION OF EMBODIMENTS

Laminated body 1 of the present invention has a leather layer 2, fiber layer 3, and an adhesive layer 4 between the leather layer and the fiber layer.

(Leather Layer 2)

The leather layer 2 in the laminated body 1 of the present invention consists of the natural leather wherein the reticular layer is drastically removed. In the present invention, the “natural leather” includes but is not limited to those originated from mammalian including cows, horses, pigs, goats, sheep, deer, kangaroos; birds including ostriches; reptiles including snakes and crocodiles. Especially, cowhide of large area with high versatility is preferred. The biological leather collection site to become the source of the natural leather is not especially limited. Raw hides constitute of epidermis, dermis and subcutaneous tissue (muscle, fat, and the like). The leather is made by tanning only the dermis among the above. As a method of tanning, Wet white, Wet blue and the combination of the two are used.

Dermis can be differentiated into papillary layer of the upper layer and reticular layer of the lower layer. The reticular layer comprises most part of the dermis. The leather layer 2 of the present invention constitutes by drastic removal of the reticular layer of the leather. The method of removing the reticular layer is not especially limited, using the conventional method, can be done by scraping, cutting or tearing. For instance, it can be done by shaving off the reticular layer to the desired thickness using the shaving machine.

Regarding the laminated body of the present invention, the percentage of thickness of the reticular layer in the leather layer is 5% or lower, the percentage of thickness of the papillary layer is 95% or higher. Also, preferably, the percentage of the thickness of the reticular layer is 3% or lower, the percentage of the thickness of the papillary layer is 97% or higher, more preferably, the percentage of the thickness of the reticular layer is 1% or lower, the percentage of the thickness of the papillary layer is 99% or higher. In the present invention, by removing the reticular layer of the leather and keeping the percentage of the papillary layer and the reticular layer within the above range, loose grain is suitably prevented, and the weight of the finally obtained laminated body is suitably weight trimmed.

The thickness of the leather layer is preferably 0.3-0.5 mm, more preferably 0.3-0.45 mm, even more preferably 0.3-0.4 mm. When the thickness of the leather layer exceeds the above range, loose grain may occur, or issues occur such as the finally obtained weight of the laminated body becomes too heavy.

Note that in the present invention, the thickness of each layer is determined by measuring the thickness of 10 points on the cross section of the laminate body and taking the average value.

(Fiber Layer 3)

Regarding the fiber layer 3 in the laminated body 1 of the present invention, the optional one can be used within the range wherein the object of the present invention is not hindered, for instance: natural fibers such as cotton and wool; synthetic fibers such as polyethylene, polyamide, polyester, acrylic and polyurethane; regenerated fibers such as rayon; and non-woven fabrics, knitted fabrics or woven fabrics comprising these combinations can be used. From adhesiveness, cushioning characteristic and environmental aspects, preferably, knitted fabrics, woven fabrics and nonwoven fabrics made of spun yarn (short fibers) of natural fibers are used.

The thickness of the fiber layer is preferably 0.2-2.0%, more preferably 0.3-1.5 mm, particularly preferably 0.5-1.2 mm. If the thickness of the fiber layer is within the aforementioned range, a laminated body wherein the weight and hardness of the natural leather are improved can be obtained.

Weight per unit area of the fiber layer is preferably 30-800 g/m², more preferably 40-350 g/m², particularly preferably 50-150 g/m². If the weight per unit area of the fiber layer is within the aforementioned range, a laminated body wherein the weight and hardness of the natural leather are improved can be obtained.

(Adhesive Layer 4)

For an adhesive used in the adhesive layer 4, the optional one can be used within the range wherein the object of the present invention is not hindered, for instance: acrylic resin adhesive, urethane resin adhesive, cyanoacrylate adhesive, cellulose adhesive, ethylene-vinyl acetate adhesive, epoxy resin adhesive, silicone adhesive, rubber adhesive, vinyl chloride adhesive, polyamide adhesive. Preferably, acrylic resin adhesive or urethane resin adhesive are used.

(Surface-treating Layer)

Also, on the surface of the leather layer 2 of the laminated body 1 of the present invention, one or more surface-treating layers may be optionally formed according to desired purposes such as adjustment of coloring and gloss, abrasion resistance and the like.

(Lamination)

Also, under the fiber layer 3 of the laminated body 1 of the present invention, urethane foam, non-woven fabric, knitted fabric, woven fiber, and the like are bonded using a method such as adhesive or frame lamination and the like so that cushioning characteristic is applied to the laminated body 1, and the sense of touch from the leather layer 2 can be further improved.

The weight per unit area of the laminated body 1 of the present invention is preferably 300-600 g/m², more preferably 300-500 g/m², particularly preferably 300-450 g/m². The laminated body of the present invention can achieve weight-trimming of 20-70% compared with the natural leather.

The elongation percentage of the laminated body 1 of the present invention is preferably 30-80%, more preferably 35-65%, particularly preferably 40-60%. The laminated body of the present invention has the aforementioned elongation percentage, so that there are less wrinkles, it is easy to sew, and moderate elasticity is achieved. The method of measuring the elongation percentage is the elongation at the time of JIS K6251 cutting or the method of testing the fabric of JIS L 1096 woven or knitted fabric.

The laminated body of the present invention can be manufactured by (A) a process of tanning and the like to a raw hide to produce a leather, (B) a process of removing a predetermined amount of a reticular layer of the aforementioned leather to obtain a leather layer, and (C) a process of laminating the a aforementioned leather layer and a fiber layer through an adhesive layer.

The lamination process is not particularly limited, however, it can be performed by: a method of applying a liquid adhesive to the backside of the leather layer and/or the fiber layer, or spraying and drying by superimposing the both; a method of enclosing the hot melt adhesive layer between the leather layer and the fiber layer, pasting together using press ironing machine and the like. Especially, the method of applying an adhesive using a coater to the backside of the leather layer and/or the fiber layer and drying by superimposing the both is preferable.

(Use)

The laminated body of the present invention has the following advantages: there are no loose grain, less wrinkles occurrence, it is easy to sew, is lightweight, and has high tear strength. Therefore, it can be used in various fields including vehicle interior materials, interior materials, bags, shoes, clothing, and the like. Also, the laminated body of the present invention satisfies the physical property required as a vehicle interior material, especially a vehicle seat wherein a moderate elasticity is expected.

Working Example

The present invention will be further explained in details giving working examples; however, the present invention is not limited to the working examples.

(Working Example 1)

A reticular layer of a leather (Thickness 1.2 mm, weight 980 g/m² per unit area), prepared by performing tanning and the like to a cow rawhide, is completely removed by using a shaving machine (Made by RIZZI), and by leaving only a papillary layer, made into a leather layer (Thickness 0.40 mm). A laminated body was obtained (Thickness 0.62 mm, weight 407 g/m²per unit area) by applying 30 g/m² of a liquid adhesive (water-soluble acrylic resin made by Lanxess) to a fiber layer (Thickness 0.2 mm, weight 55 g/m² per unit area) comprising cotton thread short fibers, and by superimposing on the leather layer and drying.

(Working Example 2)

The reticular layer of the leather (Thickness 1.2 mm, weight 980 g/m² per unit area), prepared by performing tanning and the like to the cow rawhide, is removed by using the shaving machine (Made by RIZZI), and made into a leather layer (Thickness 0.42 mm; the percentage of the thickness of the reticular layer is 5%; the percentage of the thickness of the papillary layer is 95%). A laminated body was obtained (Thickness 0.64 mm, weight 430 g/m² per unit area) by applying 30 g/m² of the liquid adhesive (water-soluble acrylic resin made by Lanxess) to a fiber layer (Thickness 0.2 mm, weight 55 g/m² per unit area) comprising cotton thread short fibers, and by superimposing on the leather layer and drying.

(Control)

A cow leather prepared by performing tanning and the like to a raw hide (Thickness 1.2 mm, weight 980 g/m² per unit area).

(Comparative Example 1)

A part of a reticular layer of a cow leather (Thickness 1.2 mm) is removed by using the shaving machine (Made by RIZZI), and a leather layer was obtained (Thickness 0.50 mm; the percentage of the thickness of the reticular layer is 20%; the percentage of the thickness of the papillary layer is 80%). A laminated body was obtained (Thickness 0.72 mm, weight 497 g/m² per unit area) by applying 30 g/m² of the liquid adhesive (water-soluble acrylic resin made by Lanxess) to the fiber layer (Thickness 0.2 mm, weight 55 g/m² per unit area) comprising cotton thread short fibers, and by superimposing on the leather layer and drying.

(Comparative Example 2)

The reticular layer of the leather (Thickness 1.2 mm, weight 980 g/m² per unit area), prepared by performing tanning and the like to a cow rawhide, is completely removed by using the shaving machine (Made by RIZZI), leaving only the papillary layer (Thickness 0.40 mm, weight 313 g/m² per unit area).

### (Evaluation Method)

1) Elongation Percentage

In the measuring method of the elongation percentage of each laminated body, a test piece of the laminated body is pulled by a tension testing machine (Tension Speed: 100±20 mm per minute), and the elongation percentage of the laminated body until cutting is expressed in %.

Elongation Percentage (%)=100×Length during cutting (cm)/Length without load (cm)

2) Tear Strength

In the measuring method of the tear strength of each laminated body, a test piece of the laminated body is pulled up and down by a tension testing machine (Tension Speed: 200±20 mm per minute), and the maximum strength indicated by the testing machine guidelines until the test piece breaks is expressed in N.

3) Loose Grain

The presence of loose grain on the surface of each laminated body was evaluated by the following A to C.

A: None

B: Little noticeable

C: Noticeable

4. Sewability

Sewability when manufacturing vehicle seats with each laminated body was evaluated by the following A to C.

A: Easy

B: Little difficult

C: Difficult

5. Beauty after Sewing

Beauty after sewing when manufacturing vehicle seats with each laminated body was evaluated by the following A to C.

A: No wrinkles

B: Wrinkles are a little noticeable

C: Wrinkles are noticeable

TABLE 1

| | | | Working | Working | Comparative | Comparative |
|---|---|---|---|---|---|---|
| | | | Example 1 | Example 2 | Example 1 | Example 2 |
| | | Control | Laminated body of the | Laminated body of the | Laminated body consisting | Leather consisting |
| | | Normal | present invention | present invention | of reticular layer 20% | of papillary |
| | | Leather | (Papillary Layer 100%) | (Papillary Layer 95%) | papillary layer 80% | layer 100% |
| Weight (g/m2) | | 980 | 407 | 430 | 497 | 313 |
| Thickness of laminated body (mm) | | — | 0.62 | 0.64 | 0.72 | — |
| Thickness of leather layer (mm) | | 1.20 | 0.4 | 0.42 | 0.5 | 0.4 |
| Percentage of thickness of papillary | | 33/67 | 100/0 | 95/5 | 80/20 | 100/0 |
| layer and reticular layer (%/%) | | | | | | |
| Type of fiber layer | | — | Cotton thread short | Cotton thread short | Cotton thread short | — |
| | | | fiber fabric | fiber fabric | fiber fabric | |
| 1 | Growth Rate (%) | 28.3 | 40.4 | 42.9 | 41.5 | 92.5 |
| 2 | Tear Strength (N) | 246.3 | 346.2 | 374.1 | 412.2 | 65.4 |
| 3 | Loose Grain | C | A | B | B | A |
| 4 | Sewability | B | A | A | A | Torn from the stitch |
| 5 | Beauty after sewing | B | A | A | B | C |

The control is a normal leather wherein loose grain is conspicuous, it is very heavy, is low in elongation percentage and strength, is difficult to sew, and wrinkles after sewing are concerned. In contrast, it has been confirmed that in the laminated body of the present invention, deterioration of the appearance due to loose grain is suppressed, improvements are made in the weight, elongation percentage and strength, further, sewability is high, and no wrinkles are formed after sewing (Working Example 1 and 2). The loose grain has been further improved in the Working Example 1 wherein the percentage of the thickness of the papillary layer is 100%, rather than in the Working Example 2 wherein the percentage of the thickness of the papillary layer is 95%. However, the laminated body of the Comparative Example 1 wherein the percentage of the thickness of the papillary layer is 80% is, compared with the laminated body of the present invention, inferior in its improvements on loose grain and weight, and also in its beauty after sewing. Also, in the Comparative Example 2 wherein it is not laminated with the fiber layer, the strength is extremely poor and sewing is not possible.

### EXPLANATION OF REFERENCES [Numerals]

1 Laminated body

2 Leather layer

3 Fiber layer

4 Adhesive layer

1. A laminated body comprising:
a leather layer comprising a natural leather wherein a part or all of a reticular layer have been removed,
a fiber layer comprising natural and/or synthetic fiber positioned at a backside of the leather layer, and
an adhesive layer between the leather layer and the fiber layer;
wherein a percentage of a thickness of the reticular layer in the leather layer is 5% or less, and a percentage of a thickness of a papillary layer is 95% or more.

2. The laminated body of claim 1 wherein the thickness of the leather layer is less than 0.3-0.5mm.

3. The laminated body of claim 1 wherein a elongation percentage is 30-80%.

4. The laminated body of claim 1 wherein the fiber layer comprises a non-woven fabric made of a short fiber of a natural fiber.

5. A vehicle interior material comprising the laminated body of claim 1.

6. A vehicle seat comprising the laminated body of claim 1.

7. The laminated body of claim 2 wherein a elongation percentage is 30-80%.

8. The laminated body of claim 2 wherein the fiber layer comprises a non-woven fabric made of a short fiber of a natural fiber.

9. The laminated body of claim 3 wherein the fiber layer comprises a non-woven fabric made of a short fiber of a natural fiber.

10. A vehicle interior material comprising the laminated body of claim 2.

11. A vehicle interior material comprising the laminated body of claim 3.

12. A vehicle interior material comprising the laminated body of claim 4.

13. A vehicle seat comprising the laminated body of claim 2.

14. A vehicle seat comprising the laminated body of claim 3.

15. A vehicle seat comprising the laminated body of claim 4.
